(19) United States
(12) Patent Application Publication
(10) Pub. No.: US 2026/0341772 A1
(43) Pub. Date: Oct. 29, 2026

(54) TAB SUPPLY APPARATUS, TAB SUPPLY METHOD, AND BATTERY MANUFACTURING SYSTEM

(71) Applicant: SK On Co., Ltd., Seoul (KR)

(72) Inventors: Kang San KIM, Daejeon (KR); Sang Jun PARK, Daejeon (KR); Do Wan CHA, Daejeon (KR)

(21) Appl. No.: 19/661,948

(22) Filed: Apr. 29, 2026

(30) Foreign Application Priority Data
Apr. 29, 2025 (KR) 10-2025-0056368

(51) Int. Cl. H01M 10/04; H01M 50/566

(52) U.S. Cl. CPC H01M 10/0404; H01M 50/566

(57) ABSTRACT

A tab supply apparatus includes: a tray inlet unit configured to supply a tray in a first state in which a plurality of tabs are accommodated; a first stage configured to hold the tray in the first state supplied through the tray inlet unit; a second stage configured to receive the tray in the first state from the first stage; a gripper configured to grip and transfer at least one tab among the plurality of tabs accommodated in the tray in the first state on the second stage; a tray outlet unit configured to discharge, from the second stage, the tray in a second state in which the inside thereof is empty after the plurality of tabs are transferred by the gripper; and a controller configured to detect a state of the tray and to control an operation of the gripper, the tray inlet unit, and the tray outlet unit.

### CROSS-REFERENCE TO RELATED PATENT APPLICATION

The present application claims priority under 35 U.S.C. § 119(a) to Korean patent application number 10-2025-0056368 filed on Apr. 29, 2025, in the Ministry of Intellectual Property, the entire disclosure of which is incorporated by reference herein.

### BACKGROUND OF THE INVENTION

### 1. Field

The present disclosure relates to a tab supply apparatus, a tab supply method, and a battery manufacturing system. More particularly, the present disclosure relates to a battery manufacturing system having improved manufacturing efficiency.

### 2. Description of the Related Art

In general, when supplying a tab for welding the tab to an electrode assembly, a tab transferred from a tab manufacturing process is taken out of a tray and placed on a jig. Thereafter, a tab welding process is performed. In this process, unnecessary labor consumption may occur in order to load and supply the tab onto the jig. In addition, when the tab is not loaded using an appropriate loading method, equipment may fail to operate, or the tab may not be properly supplied.

### SUMMARY OF THE INVENTION

First, according to one aspect of the present disclosure, an object of the present disclosure is to improve manufacturing efficiency of a battery manufacturing system.

Second, according to another aspect of the present disclosure, an object of the present disclosure is to automate a tab supply apparatus.

Third, according to another aspect of the present disclosure, an object of the present disclosure is to improve reliability of the tab supply apparatus.

On the other hand, the present disclosure may be widely applied to green technology fields, such as an electric vehicle (EV), a battery charging station, an energy storage system (ESS), and other applications using batteries, including photovoltaics and wind power. In addition, the present disclosure may be applied to eco-friendly mobility, including electric vehicles and hybrid vehicles, for preventing climate change by reducing air pollution and greenhouse gas emissions.

A tab supply apparatus according to an embodiment of the present disclosure may include: a tray inlet unit configured to supply a tray in a first state in which a plurality of tabs are accommodated; a first stage configured to hold the tray in the first state supplied through the tray inlet unit; a second stage configured to receive the tray in the first state from the first stage; a gripper configured to grip and transfer at least one tab among the plurality of tabs accommodated in the tray in the first state on the second stage; a tray outlet unit configured to discharge, from the second stage, the tray in a second state in which the inside thereof is empty after the plurality of tabs are transferred by the gripper; and a controller configured to detect a state of the tray and to control an operation of the gripper, the tray inlet unit, and the tray outlet unit.

In an embodiment, the controller may: discharge the tray in the second state through the tray outlet unit when a state of the tray on the second stage is detected as the second state; and move another tray in the first state from the first stage to the second stage.

In an embodiment, the gripper may grip the tab and supply the tab to a predetermined target position through rotation.

In an embodiment, the gripper may grip the tab using a negative pressure method.

In an embodiment, the tab supply apparatus may further include a sensing sensor configured to detect whether the tab is gripped by the gripper.

In an embodiment, the controller may determine, through the sensing sensor, whether the tab is gripped by the gripper.

In an embodiment, a plurality of trays in the first state may be provided, and the plurality of trays in the first state may be stacked on the first stage to overlap with each other.

In an embodiment, a plurality of trays in the first state may be provided, and the plurality of trays in the first state may be arranged at the same level with respect to the first stage.

In an embodiment, the tray inlet unit may be disposed on both sides of the gripper, and the tray outlet unit may be disposed on both sides of the gripper.

In an embodiment, the first stage may be disposed on both sides of the gripper, and the second stage may be disposed on both sides of the gripper.

A method for supplying a tab according to an embodiment of the present disclosure may include: receiving, through a tray inlet unit, a tray in a first state in which a plurality of tabs are accommodated; holding the supplied tray in the first state on a first stage; supplying the tray in the first state from the first stage to a second stage; gripping and transferring at least one tab among the plurality of tabs accommodated in the tray in the first state on the second stage using a gripper; and discharging the tray in a second state in which the inside thereof is empty from the second stage after the plurality of tabs are transferred by the gripper.

In an embodiment, the discharging of the tray may include determining whether a state of the tray on the second stage is the second state.

In an embodiment, the method may further include, after the discharging of the tray, moving another tray in the first state from the first stage to the second stage.

In an embodiment, the gripping and transferring of the tab may include determining, through a sensing sensor, whether the tab is picked up by the gripper.

In an embodiment, the holding of the tray on the first stage may include providing a plurality of trays in the first state and stacking the trays on the first stage to overlap with each other.

In an embodiment, the holding of the tray on the first stage may include providing a plurality of trays in the first state and arranging the plurality of trays at the same level with respect to the first stage.

A battery manufacturing system according to an embodiment of the present disclosure may include: a tab manufacturing apparatus configured to manufacture a tab for a battery; a tab welding apparatus configured to couple the tab for a battery to an electrode assembly in which electrodes are stacked; and a tab supply apparatus configured to supply the tab for a battery manufactured by the tab manufacturing apparatus to the tab welding apparatus. The tab supply apparatus may include: a tray inlet unit configured to supply a tray in a first state in which a plurality of tabs for a battery are accommodated; a first stage configured to hold the tray in the first state supplied through the tray inlet unit; a second stage configured to receive the tray in the first state from the first stage; a gripper configured to grip and transfer at least one tab among the plurality of tabs accommodated in the tray in the first state on the second stage; a tray outlet unit configured to discharge, from the second stage, the tray in a second state in which the inside thereof is empty after the plurality of tabs are transferred by the gripper; and a controller configured to detect a state of the tray and to control an operation of the gripper, the tray inlet unit, and the tray outlet unit.

### BRIEF DESCRIPTION OF THE DRAWINGS

FIG. 1 is a view illustrating a battery manufacturing system according to an embodiment of the present disclosure.

FIG. 2 is a perspective view illustrating an example of a battery cell.

FIG. 3 is a cross-sectional view illustrating one cross-section of the battery cell of FIG. 2.

FIG. 4 is a block diagram illustrating a tab supply apparatus of FIG. 1.

FIG. 5 is a plan view illustrating an example of the tab supply apparatus of FIG. 4.

FIG. 6 is a plan view illustrating another example of the tab supply apparatus of FIG. 4.

FIG. 7 is a view illustrating a tab supply method according to an embodiment of the present disclosure.

### DETAILED DESCRIPTION

Hereinafter, preferred embodiments of the present disclosure will be described in detail with reference to the accompanying drawings. The configuration of devices or control methods described below are provided only for describing embodiments of the present disclosure and are not intended to limit the scope of the present disclosure. Throughout the specification, like reference numerals denote like elements.

Terms such as 'first', 'second', and 'third' used to describe components are employed only to avoid confusion among the components, and are not intended to imply any order, importance, or hierarchical relationship among the components. For example, an embodiment including only a second component without a first component may also be implemented.

As used herein, singular expressions include plural expressions unless the context clearly indicates otherwise.

As used herein, the term 'battery cell' may be used interchangeably with a secondary battery, a cell, or a battery. For example, a battery cell refers to a basic unit of a lithium secondary battery capable of charging and discharging electrical energy, specifically, a lithium-ion battery. The main components of the battery cell include a cathode, an anode, a separator, and an electrolyte, and these main components are accommodated in a case (or pouch) to form the battery cell. The battery cell may further include a tab electrically connected to each of the cathode and the anode and protruding to the outside of the pouch for electrical connection with an external device.

In the present disclosure, a battery manufacturing system may be a system for manufacturing any one of a battery module, a battery pack, or an energy storage system including a plurality of battery cells. Alternatively, the battery manufacturing system may be a system for manufacturing a battery pack having a CTP (Cell-to-Pack) structure in which battery cells are accommodated without a battery module.

In the present disclosure, the term “for a battery” may refer to a component included in a battery cell. For example, a tab for a battery may refer to a tab included in a battery cell.

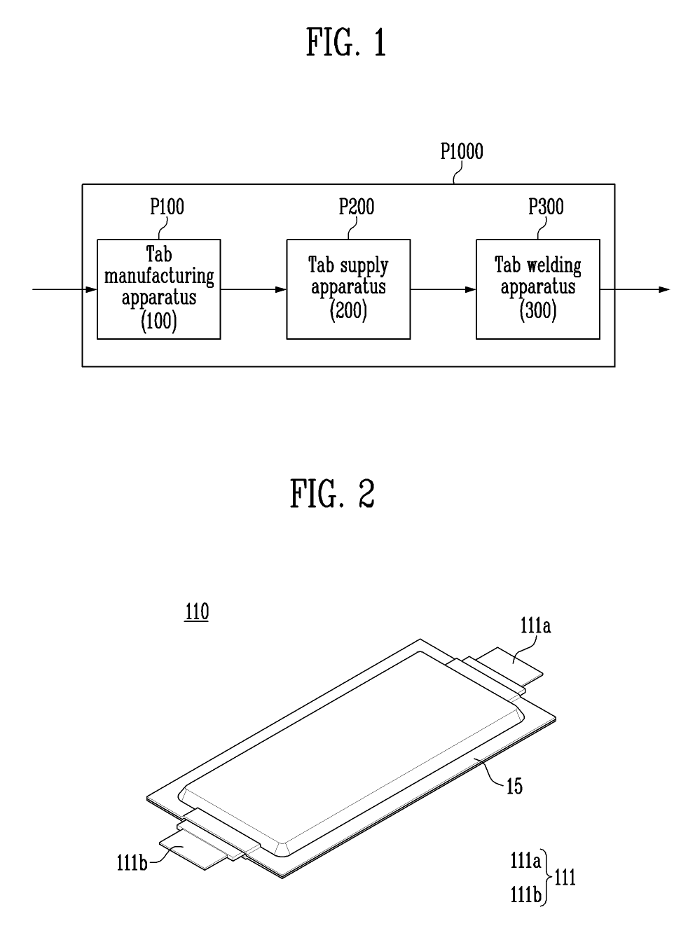

FIG. 1 is a view illustrating a battery manufacturing system according to an embodiment of the present disclosure. More specifically, FIG. 1 illustrates a portion of the battery manufacturing system that performs an electrode assembly manufacturing process P1000.

Referring to FIG. 1, the battery manufacturing system may include a tab manufacturing apparatus 100 configured to manufacture a battery tab 111, a tab welding apparatus 300 configured to couple the battery tab 111 to an electrode assembly 10 in which electrodes 10a and 10b are stacked, and a tab supply apparatus 200 configured to supply the battery tab 111 manufactured by the tab manufacturing apparatus 100 to the tab welding apparatus 300.

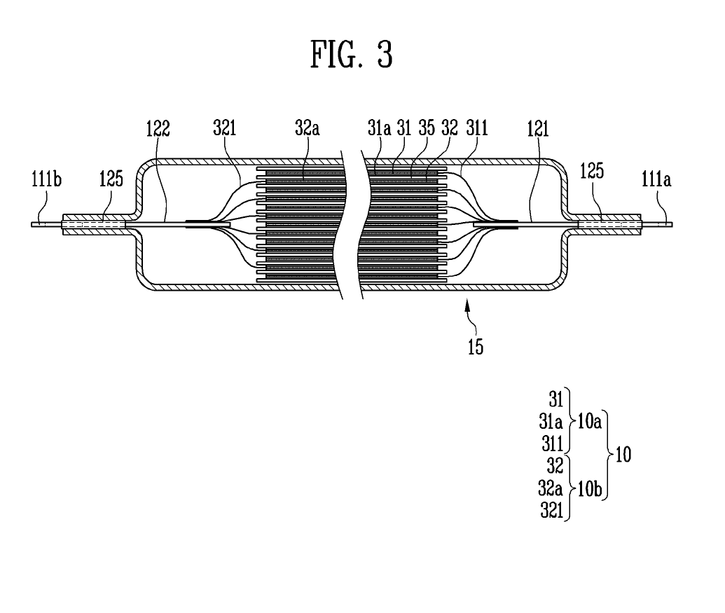

The tab manufacturing apparatus 100 may be used in a tab manufacturing process P100 for manufacturing the battery tab 111 (see FIG. 2), the tab welding apparatus 300 may be used in a tab welding process P300 for coupling the battery tab 111 to the electrode assembly 10 (see FIG. 3) in which the electrodes 10a and 10b (see FIG. 3) are stacked, and the tab supply apparatus 200 may be used in a tab supply process P200 for supplying the battery tab 111 manufactured by the tab manufacturing apparatus 100 to the tab welding apparatus 300. That is, the battery manufacturing system may include the tab manufacturing apparatus 100 configured to perform the tab manufacturing process P100, the tab welding apparatus 300 configured to perform the tab welding process P300, and the tab supply apparatus 200 configured to perform the tab supply process P200.

FIG. 2 is a perspective view illustrating an example of the battery cell. The battery cell 110 of FIG. 2 may be manufactured by the battery manufacturing system of FIG. 1.

Referring to FIG. 2, the battery cell 110 may include a cell case 15 accommodating the electrode assembly 10 (see FIG. 3) therein and a tab 111 electrically connected to the electrode assembly 10 and protruding to the outside of the cell case 15.

The tab 111 may protrude from the cell case 15 in the same direction, or alternatively, the tab 111 may protrude from the cell case 15 in opposite directions.

FIG. 3 is a cross-sectional view illustrating one cross-section of the battery cell of FIG. 2.

Referring to FIG. 3, the battery cell 110 according to the present disclosure may include: an electrode assembly 10 including a first electrode 10a, a second electrode 10b, and a separator 35 disposed between the first electrode 10a and the second electrode 10b; a cell case 15 accommodating the electrode assembly 10 therein; leads 121 and 122 electrically connected to the electrode assembly 10 in the cell case 15; and a tab 111 electrically connected to the leads 121 and 122 and protruding outward from the cell case 15.

The electrode assembly 10 may include the first electrode 10a, the second electrode 10b, and the separator 35 disposed between the first electrode 10a and the second electrode 10b. The leads 121 and 122 may include a first lead 121 electrically connected to the first electrode 10a. In addition, the leads 121 and 122 may further include a second lead 122 electrically connected to the second electrode 10b.

Similarly, the tab 111 may include a first tab 111a connected to the first lead 121 and protruding outward from the cell case 15. In addition, the tab 111 may further include a second tab 111b connected to the second lead 122 and protruding outward from the cell case 15.

Specifically, the first electrode 10a may include a negative electrode active material 31a and a first electrode plate 31 on which the negative electrode active material 31a is stacked.

Further, the first electrode plate 31 may include: a region on which the negative electrode active material 31a is stacked; and a first uncoated portion 311 on which the negative electrode active material 31a is not stacked while protruding in one direction from the region on which the negative electrode active material 31a is stacked.

A plurality of first electrode plates 31 may be provided, and the respective first uncoated portions 311 of the plurality of first electrode plates 31 may be bent and combined into one. Each of the bent first uncoated portions 311 may be electrically connected to the first lead 121.

The first tab 111a may be in contact with the first lead 121 and may protrude outward from the cell case 15.

The second electrode 10b may include a positive electrode active material 32a and a second electrode plate 32 on which the positive electrode active material 32a is stacked.

Similarly, the second electrode plate 32 may include: a region on which the positive electrode active material 32a is stacked; and a second uncoated portion 321 on which the positive electrode active material 32a is not stacked while protruding in one direction from the region on which the positive electrode active material 32a is stacked.

A plurality of second electrode plates 32 may be provided, and respective second uncoated portions 321 of the plurality of second electrode plates 32 may be bent and combined into one. Each of the bent second uncoated portions 321 may be electrically connected to the second lead 122.

The second tab 111b may be in contact with the second lead 122 and may protrude outward from the cell case 15.

The first uncoated portion 311 and the second uncoated portion 322 may protrude in opposite directions. However, as long as the first uncoated portion 311 and the second uncoated portion 322 are electrically separated from each other, the first uncoated portion 311 and the second uncoated portion 322 may protrude in the same direction.

The first lead 121 may be connected to the first tab 111a protruding outward from the cell case 15. The second lead 122 may be connected to the second tab 111b protruding outward from the cell case 15.

In order to protect a portion in which the first lead 121 and the first tab 111a, or the second lead 122 and the second tab 111b, are coupled, and to improve sealing with the cell case 15, the battery cell 110 according to the present disclosure may further include a protective film or a lead film 125 made of a polymer material.

Although the cell case 15 is illustrated as a single layer, the cell case 15 may alternatively be made of a composite material in which a plurality of layers are stacked.

Summarizing the relationship between the battery manufacturing system of FIG. 1 and the battery cell 110 of FIGS. 2 and 3, the tab manufacturing process P100 of FIG. 1 may include a process of manufacturing the tab 111 included in the battery cell 110 of FIGS. 2 and 3, the tab welding process P300 of FIG. 1 may include a process of connecting the tab 111 to the leads 121 and 122 included in the electrode assembly 10 of FIGS. 2 and 3, and the tab supplying process P200 of FIG. 1 may include a process of supplying the tab 111, manufactured by the tab manufacturing apparatus 100, to the tab welding apparatus 300 in order to connect the tab 111 to the electrode assembly 10.

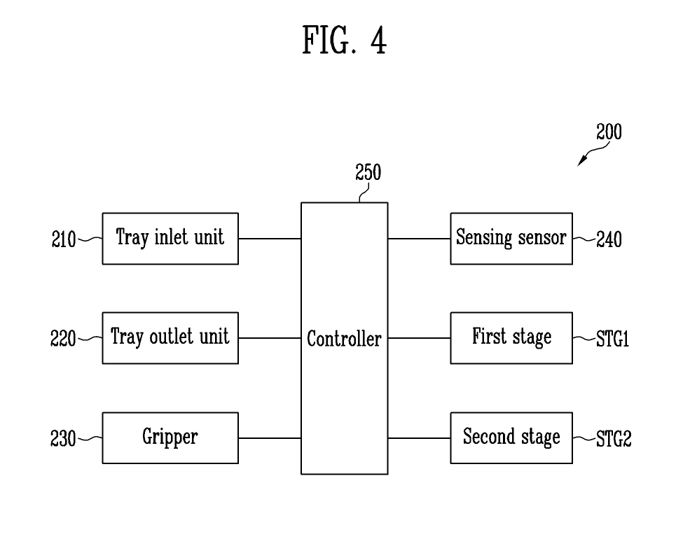

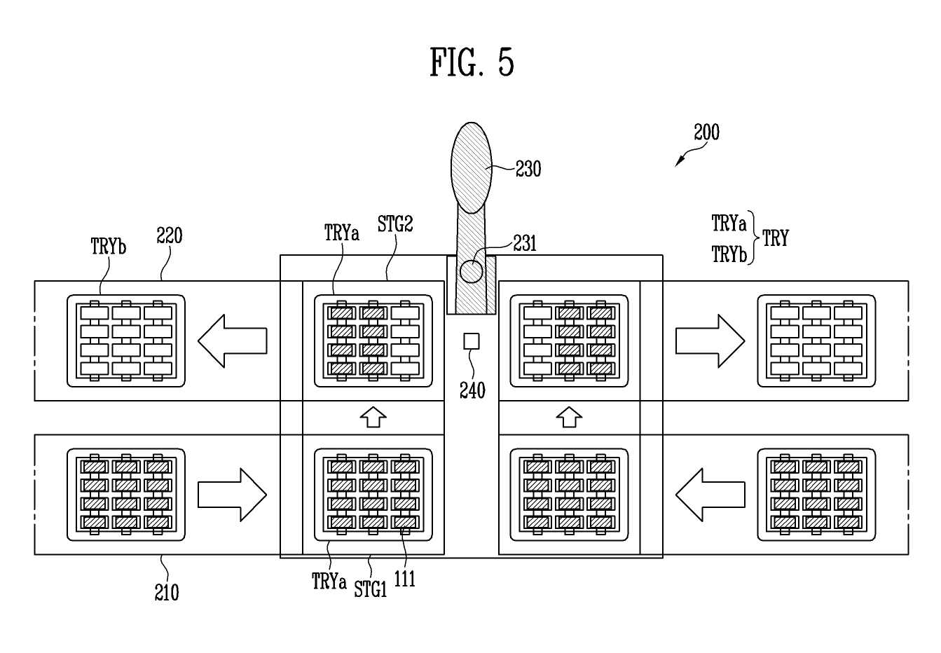

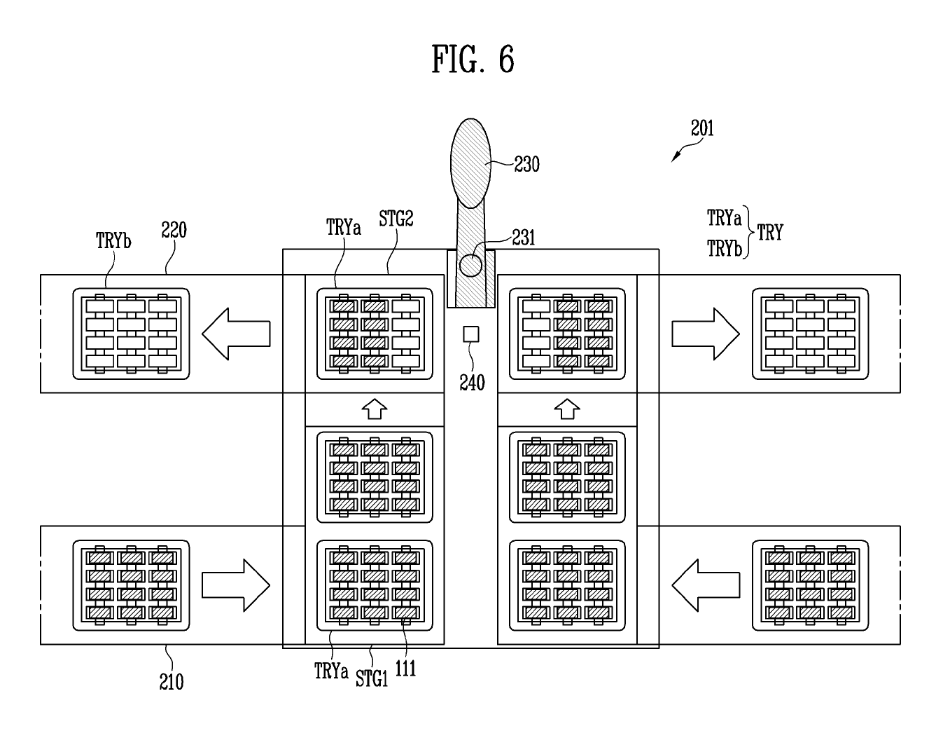

FIG. 4 is a block diagram illustrating a tab supply apparatus of FIG. 1. FIG. 5 is a plan view illustrating one example of the tab supply apparatus of FIG. 4. FIG. 6 is a plan view illustrating another example of the tab supply apparatus of FIG. 4. The tab supply apparatus 200 according to the embodiment of FIG. 5 differs from a tab supply apparatus 201 according to the embodiment of FIG. 6 in a method of stacking trays TRY on a first stage STG1.

Referring to FIGS. 4 to 6, the tab supply apparatus 200 may include: a tray inlet unit 210 configured to supply a tray TRYa in a first state in which a plurality of tabs 111 are accommodated; a first stage STG1 configured to hold the tray TRYa in the first state supplied through the tray inlet unit 210; a second stage STG2 configured to receive the tray TRYa in the first state from the first stage STG1; a gripper 230 configured to grip and transfer at least one tab 111 among the plurality of tabs 111 accommodated in the tray TRYa in the first state on the second stage STG2; a tray outlet unit 220 configured to discharge a tray TRYb in a second state in which the tray is empty after the plurality of tabs 111 are transferred by the gripper 230 from the second stage STG2; and a controller 250 configured to detect a state of the tray TRY and to control an operation of the gripper 230, the tray inlet unit 210, and the tray outlet unit 220.

The tray inlet unit 210 and the tray outlet unit 220 may respectively introduce and discharge the tray TRY into and from the tab supply apparatus 200.

Specifically, the tray inlet unit 210 may supply, to the first stage STG1, a tray TRYa in a first state in which a plurality of tabs 111 are accommodated in the tray TRY. The tray outlet unit 220 may discharge, from the second stage STG2, a tray TRYb in a second state in which the inside of the tray TRY is empty after the plurality of tabs 111 are transferred from the tray TRY. The tray TRYa in the first state may be defined as a state in which at least one tab 111 is accommodated in the tray TRY, and the tray TRYb in the second state may be defined as a state in which no tab 111 is accommodated in the tray TRY, such that the inside of the tray TRY is empty.

In an embodiment, each of the tray inlet unit 210 and the tray outlet unit 220 may be configured as a conveyor belt to move the tray TRY. However, the embodiments of the present disclosure are not limited thereto. Each of the tray inlet unit 210 and the tray outlet unit 220 may be configured in any form as long as each of the tray inlet unit 210 and the tray outlet unit 220 is capable of moving the tray TRY.

Each of the first stage STG1 and the second stage STG2 may be a space for holding in order to supply the tab 111 from the tab supply apparatus 200 to the tab welding apparatus 300.

Specifically, the first stage STG1 may hold the tray TRYa in the first state transferred through the tray inlet unit 210. That is, the first stage STG1 may be a space for holding to provide the tray TRYa in the first state to the second stage STG2 that supplies the tab 111.

A plurality of trays TRYa in the first state may be provided on the first stage STG1. In an embodiment, the plurality of trays TRYa in the first state may be stacked on the first stage STG1 to overlap with each other (see FIG. 5). That is, the plurality of trays TRY in the first state may be stacked in a direction perpendicular to a top surface of the first stage STG1. In this case, the tray TRYa in the first state supplied from the tray inlet unit 210 may be stacked in one direction on another tray TRYa in the first state disposed on the first stage STG1 through a separate transfer unit. In another embodiment, a plurality of trays TRYa in the first state may be arranged at the same level with respect to the first stage STG1 (see FIG. 6). That is, the plurality of trays TRY in the first state may be arranged on the top surface of the first stage STG1 without being stacked, and the trays TRY may be sequentially moved toward the second stage STG2 through a transfer unit included in the first stage STG1.

The second stage STG2 may receive the tray TRYa in the first state from the first stage STG1. The second stage STG2 may be a space for holding the tray TRYa in the first state in order to provide the tabs 111 disposed in the tray TRYa in the first state to the gripper 230. Further, when all of the tabs 111 are transferred from the tray TRYa in the first state on the second stage STG2, and the tray becomes a tray TRYb in a second state in which the inside is empty, the tray TRYb in the second state may be discharged to the tray outlet unit 220.

In an embodiment, each of the first stage STG1 and the second stage STG2 may further include a transfer device configured as a conveyor belt. Accordingly, the transfer device may receive the tray TRY from the tray inlet unit 210, move the tray TRY from the first stage STG1 to the second stage STG2, and discharge the tray TRY from the second stage STG2 to the tray outlet unit 220. However, the embodiments of the present disclosure are not limited to the conveyor belt, and any configuration may be employed as long as the transfer device is capable of moving the tray TRY.

The gripper 230 may grip and transfer at least one tab 111 among the plurality of tabs 111 accommodated in the tray TRYa in the first state on the second stage STG2. The gripper 230 may grip the tab 111 and supply the tab 111 to a predetermined target position through rotation. In this case, the predetermined target position may be within a region in which welding of the tab 111 is prepared in the tab welding apparatus 300, or within a region in which the tab 111 is welded.

The gripper 230 may rotate about a rotation shaft 231. Further, a grip portion included in the gripper 230 and configured to grip the tab 111 may move within the gripper 230 in a longitudinal direction of the gripper 230. In this case, the longitudinal direction of the gripper 230 may be defined as a direction in which the gripper 230 extends from the rotation shaft 231. Accordingly, the tab 111 gripped by the grip portion of the gripper 230 may move while rotating as the rotation shaft 231 rotates, and may move linearly within the gripper 230 in the longitudinal direction of the gripper 230. In an embodiment, in order for the gripper 230 to grip all of the tabs 111 in the tray TRYa in the first state, a rotation radius of the gripper 230 may be greater than or equal to a maximum distance between the rotation shaft 231 and each of the tabs 111 in the tray TRYa in the first state. However, the embodiments of the present disclosure are not limited thereto. The gripper 230 may operate in any manner as long as the gripper is capable of gripping all of the tabs 111 in the tray TRYa in the first state and supplying the same to a predetermined target position.

The gripper 230 may grip the tab 111 using a negative pressure method. That is, the gripper 230 may grip the tab 111 by suction. However, the embodiments of the present disclosure are not limited thereto.

The sensing sensor 240 may detect whether the tab 111 is gripped by the gripper 230. The sensing sensor 240 may detect whether the tab 111 is gripped through an image sensor or by sensing a weight gripped by the gripper 230. In FIGS. 5 and 6, the sensing sensor 240 is illustrated as being configured separately from the gripper 230; however, the gripper 230 may be attached to the sensing sensor 240 or may be included within the sensing sensor 240. That is, the sensing sensor 240 may be disposed at any position within the tab supply apparatus 200 as long as the sensing sensor is capable of determining whether the tab 111 is gripped.

The controller 250 may detect a state of the tray TRY, control an operation of the gripper 230 and the first stage STG1, the second stage STG2, the tray inlet unit 210, and the tray outlet unit 220, and determine whether the tab 111 is gripped by the gripper 230 through the sensing sensor 240.

The controller 250 may detect the state of the tray TRY to determine whether the tray TRY is in the first state TRYa or the second state TRYb. That is, when the controller 250 detects that the state of the tray TRY on the second stage STG2 is the second state TRYb, the controller 250 may discharge the tray TRYb in the second state through the tray outlet unit 220. Thereafter, the controller 250 may control the transfer devices included in each of the first stage STG1 and the second stage STG2 to move another tray TRY in the first state from the first stage STG1 to the empty second stage STG2. Further, when the first stage STG1 is empty, the controller 250 may control the tray inlet unit 210 to supply the tray TRYa in the first state to the first stage STG1. By detecting the state of the tray TRY and controlling the tray inlet unit 210, the first stage STG1, the second stage STG2, and the tray outlet unit 220, the controller 250 may allow the tray TRY to be continuously supplied to the tab supply apparatus 200.

The controller 250 may control the operation of the gripper 230 such that the gripper 230 grips the tab 111, and may move the gripper 230 to a predetermined target position while the gripper 230 grips the tab 111. In this case, the controller 250 may determine whether the tab 111 is gripped by the gripper 230 using the sensing sensor 240.

Further, the controller 250 may supply the tab 111, which is moved to the predetermined target position, to the corresponding position. Thereafter, when the controller 250 detects that the tab 111 is not disposed at the predetermined target position and that the tab 111 is not gripped by the gripper 230, the controller 250 may control the operation of the gripper 230 to re-supply the tab 111 to the predetermined target position. That is, the controller 250 may control the gripper 230 to grip and transfer the tab 111 from the tray TRYa in the first state on the second stage STG2. By detecting states of the gripper 230 and the predetermined target position and controlling the operation of the gripper 230, the controller 250 may allow the tab 111 to be continuously supplied from the tray TRY to the tab welding apparatus 300.

In an embodiment, the tray inlet unit 210 may be disposed on both sides of the gripper 230. The tray outlet unit 220 may be disposed on both sides of the gripper 230. Further, the first stage STG1 may be disposed on both sides of the gripper 230. The second stage STG2 may be disposed on both sides of the gripper 230. That is, each of the tray inlet unit 210, the first stage STG1, the second stage STG2, and the tray outlet unit 220 may be disposed on both sides of the gripper 230, and may be provided in pairs. Accordingly, a supply efficiency of the tabs 111 of the tab supply apparatus 200 may be improved. However, the embodiments of the present disclosure are not limited thereto. Each of the tray inlet unit 210, the first stage STG1, the second stage STG2, and the tray outlet unit 220 may be provided as one or three or more, and the gripper 230 may also be provided as two or more.

In an embodiment, by automatically and continuously supplying the tabs 111 using the tray TRY provided in the first state TRYa in which the tabs 111 are accommodated, the tab supply apparatus 200 may omit a process of arranging the tabs 111 in a separate jig in order to supply the tabs 111 manufactured by the tab manufacturing apparatus 100 to the tab welding apparatus 300. Accordingly, unnecessary labor consumption may be prevented and manufacturing efficiency may be improved. Further, since it is not necessary to separately consider a loading method used when arranging the tabs 111 in a separate jig, problems in which equipment fails to operate or the tabs 111 are not properly supplied due to an incorrect loading method may be prevented.

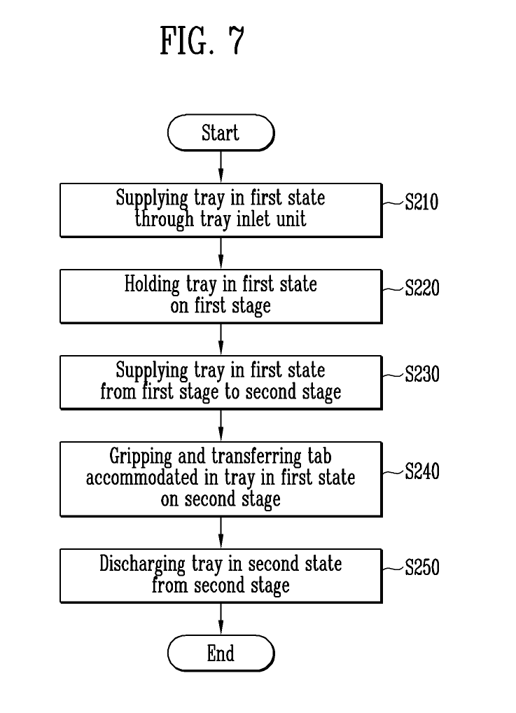

FIG. 7 is a view illustrating a tab supply method according to an embodiment of the present disclosure. The tab supplying method of FIG. 7 may be included in a tab supplying process performed in the battery manufacturing system of FIG. 1.

Referring to FIG. 7, the tab supplying method may include: a process S210 of receiving a tray TRYa in a first state in which a plurality of tabs 111 are accommodated through the tray inlet unit 210; a process S220 of holding the supplied tray TRYa in the first state on the first stage STG1; a process S230 of supplying the tray TRYa in the first state from the first stage STG1 to the second stage STG2; a process S240 of gripping and transferring at least one tab 111 among the plurality of tabs 111 accommodated in the tray TRYa in the first state on the second stage STG2 using the gripper 230; and a process S250 of discharging, from the second stage STG2, a tray TRYb in a second state in which the interior is empty after the plurality of tabs 111 are transferred by the gripper 230.

Accordingly, the tabs 111 may be continuously supplied to the tab welding apparatus 300 without requiring additional manpower.

In an embodiment, the process S220 of holding the tray TRY on the first stage STG1 may include providing a plurality of trays TRYa in the first state and stacking the trays TRYa on the first stage STG1 to overlap with each other (see FIG. 5). In another embodiment, the process S220 of holding the tray TRY on the first stage STG1 may include providing a plurality of trays TRYa in the first state and arranging the trays TRYa at the same level with respect to the first stage STG1 (see FIG. 6). Accordingly, since a plurality of trays TRY may be provided on the first stage STG1, the trays TRY may be more efficiently supplied from the first stage STG1 to the second stage STG2.

In an embodiment, the process S240 of gripping and transferring the tab 111 may include determining, through the sensing sensor 240, whether the tab 111 has been picked up by the gripper 230. This is intended to determine whether the tab 111 is picked up, thereby improving reliability of the operation of the gripper 230 and preventing a problem in which the tab 111 is not properly supplied.

In an embodiment, the process S250 of discharging the tray TRY may include determining whether the state of the tray TRY on the second stage STG2 is the second state TRYb.

In an embodiment, the tab supplying method may further include, after the process of discharging the tray TRY, moving another tray TRY in the first state from the first stage STG1 to the second stage STG2. Accordingly, by operating the tray inlet unit 210, the first stage STG1, the second stage STG2, and the tray outlet unit 220, the trays TRY accommodating the tabs 111 may be continuously supplied.

As described above, when the tabs 111 are supplied using the tab supply apparatus 200, the tab supplying process may be continuously performed without additional manpower and may be automated.

First, according to one aspect of the present disclosure, the object of the present disclosure is to improve the manufacturing efficiency of the battery manufacturing system.

Second, according to another aspect of the present disclosure, the object of the present disclosure is to automate the tab supply apparatus.

Third, according to another aspect of the present disclosure, the object of the present disclosure is to improve the reliability of the tab supply apparatus.

The present disclosure may be implemented in various modified forms, and thus the scope of the present disclosure is not limited to the above-described embodiments. Accordingly, any modified embodiment that includes the constituent elements of the claims of the present disclosure should be construed as falling within the scope of the present disclosure.

What is claimed is:

1. A tab supply apparatus comprising:
a tray inlet unit configured to supply a tray in a first state in which a plurality of tabs are accommodated;
a first stage configured to hold the tray in the first state supplied through the tray inlet unit;
a second stage configured to receive the tray in the first state from the first stage;
a gripper configured to grip and transfer at least one tab among the plurality of tabs accommodated in the tray in the first state on the second stage;
a tray outlet unit configured to discharge, from the second stage, the tray in a second state in which the inside thereof is empty after the plurality of tabs are transferred by the gripper; and
a controller configured to detect a state of the tray and to control an operation of the gripper, the tray inlet unit, and the tray outlet unit.

2. The tab supply apparatus of claim 1, wherein the controller is configured to:
discharge the tray in the second state through the tray outlet unit when a state of the tray on the second stage is detected as the second state; and
move another tray in the first state from the first stage to the second stage.

3. The tab supply apparatus of claim 1, wherein the gripper is configured to grip the tab and supply the tab to a predetermined target position through rotation.

4. The tab supply apparatus of claim 1, wherein the gripper is configured to grip the tab using a negative pressure method.

5. The tab supply apparatus of claim 1, further comprising a sensing sensor configured to detect whether the tab is gripped by the gripper.

6. The tab supply apparatus of claim 5, wherein the controller is configured to determine, through the sensing sensor, whether the tab is gripped by the gripper.

7. The tab supply apparatus of claim 1, wherein a plurality of trays in the first state are provided, and
the plurality of trays in the first state are stacked on the first stage to overlap with each other.

8. The tab supply apparatus of claim 1, wherein a plurality of trays in the first state are provided, and
the plurality of trays in the first state are arranged at the same level with respect to the first stage.

9. The tab supply apparatus of claim 1, wherein the tray inlet unit is disposed on both sides of the gripper, and
the tray outlet unit is disposed on both sides of the gripper.

10. The tab supply apparatus of claim 9, wherein the first stage is disposed on both sides of the gripper, and
the second stage is disposed on both sides of the gripper.

11. A method for supplying a tab, the method comprising:
receiving, through a tray inlet unit, a tray in a first state in which a plurality of tabs are accommodated;
holding the supplied tray in the first state on a first stage;
supplying the tray in the first state from the first stage to a second stage;
gripping and transferring at least one tab among the plurality of tabs accommodated in the tray in the first state on the second stage using a gripper; and
discharging the tray in a second state in which the inside thereof is empty from the second stage after the plurality of tabs are transferred by the gripper.

12. The method of claim 11, wherein the discharging of the tray comprises determining whether a state of the tray on the second stage is the second state.

13. The method of claim 12, further comprising, after the discharging of the tray, moving another tray in the first state from the first stage to the second stage.

14. The method of claim 11, wherein the gripping and transferring of the tab comprises determining, through a sensing sensor, whether the tab is picked up by the gripper.

15. The method of claim 11, wherein the holding of the tray on the first stage comprises providing a plurality of trays in the first state and stacking the trays on the first stage to overlap with each other.

16. The method of claim 11, wherein the holding of the tray on the first stage comprises providing a plurality of trays in the first state and arranging the plurality of trays at the same level with respect to the first stage.

17. A battery manufacturing system comprising:
a tab manufacturing apparatus configured to manufacture a tab for a battery;
a tab welding apparatus configured to couple the tab for a battery to an electrode assembly in which electrodes are stacked; and
a tab supply apparatus configured to supply the tab for a battery manufactured by the tab manufacturing apparatus to the tab welding apparatus,
wherein the tab supply apparatus comprises:
a tray inlet unit configured to supply a tray in a first state in which a plurality of tabs for a battery are accommodated;
a first stage configured to hold the tray in the first state supplied through the tray inlet unit;
a second stage configured to receive the tray in the first state from the first stage;
a gripper configured to grip and transfer at least one tab among the plurality of tabs accommodated in the tray in the first state on the second stage;
a tray outlet unit configured to discharge, from the second stage, the tray in a second state in which the inside thereof is empty after the plurality of tabs are transferred by the gripper; and
a controller configured to detect a state of the tray and to control an operation of the gripper, the tray inlet unit, and the tray outlet unit.
